(19) United States
(12) Patent Application Publication
(10) Pub. No.: US 2007/0297173 A1
(43) Pub. Date: Dec. 27, 2007

(54) ILLUMINATION SYSTEM

(75) Inventor: Sze-Ke Wang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/745,465

(22) Filed: May 8, 2007

(30) Foreign Application Priority Data
Jun. 21, 2006 (TW) 95122236

(51) Int. Cl. F21V 7/08; F21V 1/00

(52) U.S. Cl. 362/241; 362/237

(57) ABSTRACT

An illumination system includes a first reflective element, a first lamp, a second lamp and a second reflective element. The second lamp is disposed on a second axis, the first reflective element and the first lamp are disposed at opposite sides of the second axis and on a first axis intersecting the second axis. The first lamp and the second lamp have a first light emitting section, a second light emitting section and emit a first light beam, a second light beam respectively. The second reflective element is located in front of a part of the first light emitting section and the second light emitting section. The first and second light beams are reflected by at least one of the first and second lamps and the first and second reflective elements, and then are combined with each other and transmit in a direction away from the second lamp.

### CROSS-REFERENCE TO RELATED APPLICATION

This application claims the priority benefit of Taiwan application serial no. 95122236, filed Jun. 21, 2006. All disclosure of the Taiwan application is incorporated herein by reference.

### BACKGROUND OF THE INVENTION

1. Field of Invention

The present invention relates to an illumination system, and more particularly, to an illumination system with multiple lamps.

2. Description of the Related Art

Referring to FIG. 1, a conventional double-lamp illumination system 100 includes a first lamp 110, a second lamp 120 and a reflector 130. The first lamp 110 and the second lamp 120 are disposed oppositely, while the reflector 130 is disposed between the first lamp 110 and the second lamp 120. The reflector 130 has two reflection surfaces 132 and 134 which are respectively inclined to the axis 50 with an angle of 45 degree.

The first lamp 110 and the second lamp 120 respectively include a burner 112 and a parabolic reflective lampshade 114 and a burner 122 and a parabolic reflective lampshade 124. The burners 112 and 122 are located on a same axis 50. The parabolic reflective lampshades 114 and 124 are used to make the light emitted from the burners 112 and 122 into parallel light beams 112a and 122a, which are both parallel to the axis 50. A portion of the parallel light beam 112a and a portion of the parallel light beam 122a are respectively reflected by the reflection surface 132 and the reflection surface 134 of the reflector 130 to provide an illumination light beam 140. The rest portions of the parallel light beams 112a and 122a not reflected by the reflector 130 are respectively reflected by the parabolic reflective lampshades 124 and 114 to the reflector 130, and then are reflected again respectively by the reflection surfaces 134 and 132 to provide the illumination light beam 140.

The above-described double-lamp illumination system 100 has a larger structure, leading to a clumsy projection apparatus. Obviously, such a clumsy illumination system 100 does not follow the slim and light tendency of a modern electronic product and, hence, does not meet the design requirement today. In addition, the components employed in the double-lamp illumination system 100 have larger volumes and cost more. In particular, when the above-described conventional illumination system 100 is applied to a projection apparatus having a light integration rod (LIR), a light condenser or multiple light condensers are required to be added for converging light beams, which further increases the production cost of the projection apparatus. Furthermore, if one of the first lamp 110 and the second lamp 120 is damaged, the projected image of the illumination system will be dimmed in a half field.

Referring to FIG. 2, another conventional double-lamp illumination system 200 has an LIR 210 with a light reflection surface 212, a light incident surface 214 and a light exit surface 216 thereon. A first lamp (not shown) of the illumination system 200 provides a first light beam 222, which gets incident into the LIR 210 from the light incident surface 214, while a second lamp (not shown) provides a second light beam 232, which gets incident into the LIR 210 via the reflection of the light reflection surface 212. The first light beam 222 and the second light beam 232 are combined together in the LIR 210 and then emitted from the light exit surface 216.

For the above-described illumination system 200 applied in a projection apparatus, the light beam emitted from the light exit surface 216 transmits to a light valve and the etendue of the light beam must match the size of the light valve. If the size of the LIR 210 is larger than that of the one employed by a single-lamp illumination system, although the most portion of the first light beam 222 and the second light beam 232 enter the LIR 210, the etendue of the light beam reaching the light valve would be far larger than the amount required to match the size of the light valve due to a larger area of the light exit surface 216, which leads to a poor light utilization efficiency of the illumination system 200. On the other hand, if the LIR 210 has the same size as that of the one employed by a single-lamp illumination system, the system still has a poor light converging efficiency since the areas of the light incident surface 214 and the light reflection surface 212 are approximately the half of the light incident surface area of the LIR in a single-lamp illumination system, which results in a poor light utilization efficiency of the illumination system 200 as well. In addition, the LIR 210 in the conventional illumination system has a complicated structure and a higher production cost.

Referring to FIG. 3, another yet conventional double-lamp illumination system 300 includes a first lamp 310, a second lamp 320, a beam splitter 330 and a reflective mirror 340. The first lamp 310 includes a burner 312 and a parabolic reflective lampshade 314 making the light emitted from the burner 312 into a first light beam 316. The second lamp 320 includes a burner 322 and a parabolic reflective lampshade 324 making the light emitted from the burner 322 into a second light beam 326. The beam splitter 330 is disposed in front of both the light emitting sections 314a and 324a of the parabolic reflective lampshades 314 and 324, the reflective mirror 340 is disposed at a place opposite to the light emitting section 314a of the parabolic reflective lampshades 314, and the position of the second lamp 320 and the position of the reflective mirror 340 are interchangeable to each other.

The beam splitter 330 is passing a portion of a light beam and reflecting the rest portion thereof. A portion of the first light beam 316 reflected by the beam splitter 330 is combined with a portion of the second light beam 326 passing the beam splitter 330 to provide a parallel illumination light beam 302. A portion of the second light beam 326 reflected by the beam splitter 330 and a portion of the first light beam 316 passing the beam splitter 330 are reflected by the reflective mirror 340 and return back to the beam splitter 330, and a portion of the light beam passes the beam splitter 330 and is reflected by the first lamp 310 for usage again, while another portion of the light beam is reflected by the beam splitter 330 to the second lamp 320 to be reflected by the second lamp 320 for usage again.

However, every time the light beam is reflected by the lamp, the optical path of the light beam is changed slightly. Therefore, after multiple transmits with passing the beam splitter 330 and being reflected by the lamp, the optical path of the light beam offsets from the original optical path gradually, resulting in a poor light converging efficiency with the system. An increased assembly accuracy of the beam splitter 330 and the reflective mirror 340 can alleviate the problem for the light beam to offset the original optical path, but a higher cost must be paid. Additionally, during a light beam passes or is reflected by the beam splitter 330, some heat energy of the light beam is accumulated at the beam splitter 330, which requires the beam splitter 330 to be fabricated by using a heat-resistant glass or to add a fan and an air-circulation component to dissipate the heat, and all these result in an increasing cost.

### SUMMARY OF THE INVENTION

An objective of the present invention is to provide an illumination system with a compact structure.

Another objective of the present invention is to provide an illumination system having a higher light combining efficiency.

Another yet objective of the present invention is to provide an illumination system capable of producing an illumination light beam with high luminance.

To achieve one, some or all of the above-mentioned or other objectives, the present invention provides an illumination system including a first reflective element, a first lamp, a second lamp and a second reflective element. The first reflective element and the first lamp are disposed on a first axis, the second lamp is disposed on a second axis interesting the first axis, and the first reflective element and the first lamp are located at opposite sides of the second axis, respectively. The first lamp has a first light emitting section and emits a first light beam towards the first reflective element. The second lamp has a second light emitting section and emits a second light beam towards the intersection of the first axis and the second axis. The second reflective element is disposed between the first lamp and the first reflective element and located in front of a part of the first light emitting section and in front of a part of the second light emitting section. The second reflective element has a first reflection surface and a second reflection surface opposite to each other. The first reflection surface faces the first light emitting section and the second reflection surface faces the second light emitting section. Moreover, a part of the second light beam directly transmits in a direction away from the second lamp, the first light beam and another part of the second light beam are reflected by at least one of the first lamp, the second lamp, the first reflective element and the second reflective element, and then transmit in the direction away from the second lamp and get combined with the part of the second light beam directly transmitting in the direction away from the second lamp.

The present invention further provides an illumination system including a first reflective element, a first lamp, a second lamp and a second reflective element. The first lamp and the second lamp are disposed on a first axis, the first reflective element is disposed on a second axis interesting the first axis, and the first lamp and the second lamp are located at opposite sides of the second axis, respectively. The first lamp has a first light emitting section and emits a first parallel light beam. The second lamp has a second light emitting section opposite to the first light emitting section and emits a second parallel light beam. The second reflective element is disposed between the first lamp and the second lamp and located in front of a part of the first light emitting section and in front of a part of the second light emitting section. The second reflective element has a first reflection surface and a second reflection surface opposite to each other. The first reflection surface faces the first light emitting section and the second reflection surface faces the second light emitting section. Moreover, the first parallel light beam and the second parallel light beam are reflected by at least one of the first lamp, the second lamp, the first reflective element and the second reflective element, and then get combined with one another and further transmit in a direction away from the first reflective element.

The present invention further provides an illumination system including a first reflective element and multiple light source modules. The first reflective element is disposed on an axis and the light source modules are disposed at a side of the first reflective element and located on the axis. Each of the light source modules includes a first lamp, a second lamp and a second reflective element. The first lamp and the second lamp are located at opposite sides of the axis, respectively. The first lamp has a first light emitting section and emits a first parallel light beam. The second lamp has a second light emitting section opposite to the first light emitting section and emits a second parallel light beam. The second reflective element is disposed between the first lamp and the second lamp and located in front of a part of the first light emitting section and in front of a part of the second light emitting section. The second reflective element has a first reflection surface and a second reflection surface opposite to each other. The first reflection surface faces the first light emitting section and the second reflection surface faces the second light emitting section. Moreover, the first parallel light beams and the second parallel light beams are reflected by at least one of the first lamps, the second lamps, the first reflective element and the second reflective elements, and then get combined with one another and further transmit in a direction away from the first reflective element.

The illumination system of the present invention employs fewer components and has a compact structure with a higher assembly accuracy. In addition, most of the first light beam and most of the second light beam are able to be combined with each other, which results in a better light converging efficiency. In particular, the etendue of the combined light beam is theoretically the same as the etendue of the light beam provided by a conventional illumination system with single lamp, which results in a better light utilization efficiency. Finally, the illumination system of the present invention can have multiple light source modules, which is capable of providing an illumination light beam with high luminance.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a diagram of a conventional double-lamp illumination system.

FIG. 2 is a diagram of another conventional double-lamp illumination system.

FIG. 3 is a diagram of another yet conventional double-lamp illumination system.

FIG. 4 is a diagram of an illumination system according to a first embodiment of the present invention.

FIG. 5 is a diagram of an illumination system according to a second embodiment of the present invention.

FIG. 6 is a diagram of an illumination system according to a third embodiment of the present invention.

FIG. 7 is a diagram of an illumination system according to a fourth embodiment of the present invention.

FIG. 8A and FIG. 8B are diagrams of another two illumination systems according to the fourth embodiment of the present invention.

FIG. 9 is a diagram of an illumination system according to a fifth embodiment of the present invention.

FIG. 10 is a diagram of an illumination system according to a sixth embodiment of the present invention.

FIG. 11 is a diagram of an illumination system according to a seventh embodiment of the present invention.

FIG. 12 is a diagram of an illumination system according to an eighth embodiment of the present invention.

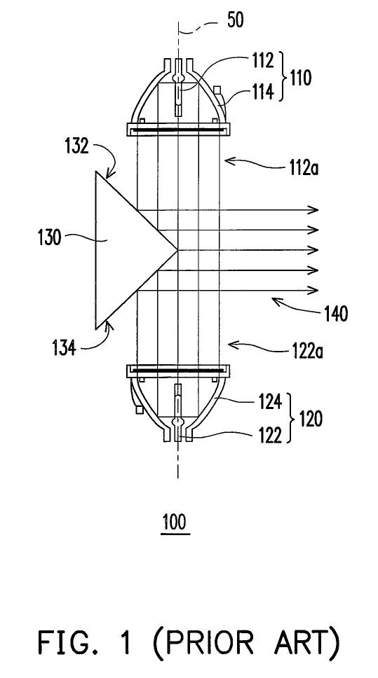

### DESCRIPTION OF THE EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

### The First Embodiment

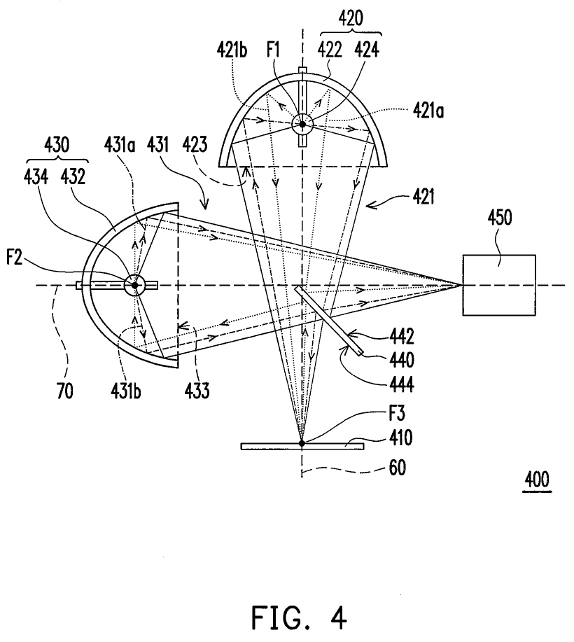

FIG. 4 is a diagram of an illumination system according to a first embodiment of the present invention. Referring to FIG. 4, the illumination system 400 of the present embodiment includes a first reflective element 410, a first lamp 420, a second lamp 430 and a second reflective element 440. The first reflective element 410 and the first lamp 420 are disposed on a first axis 60. The first lamp 420 has a first light exit section 423 and is emitting a first light beam 421 towards the first reflective element 410. The second lamp 430 is disposed on a second axis 70 intersecting the first axis 60. The second lamp 430 has a second light emitting section 433 emitting a second light beam 431 towards the intersection of the first axis 60 and the second axis 70. The first reflective element 410 and the first lamp 420 are located on the both sides of the second axis 70, respectively. The second reflective element 440 is disposed between the first lamp 420 and the first reflective element 410 and located in front of a part of the first light emitting section 423 and a part of the second light emitting section 433. The second reflective element 440 has a first reflection surface 442 and a second reflection surface 444 opposite to each other, and the first reflection surface 442 faces the first light emitting section 423, while the second reflection surface 444 faces the second light emitting section 433. In addition, a part of the second light beam 431 transmits in a direction directly away from the second lamp 430, the first light beam 421 and the rest part of the second light beam 431 are reflected by at least one of the first lamp 420, the second lamp 430, the first reflective element 410 and the second reflective element 440, and then transmits in the direction away from the second lamp 430 and combines with the part of the second light beam 431 directly transmitting in the direction away from the second lamp 430.

In the above-described illumination system 400, the first axis 60 is substantially perpendicular to the second axis 70. The first lamp 420 includes a first reflective lampshade 422 and a first burner 424 disposed inside the first reflective lampshade 422. The first reflective lampshade 422 has the first light emitting section 423 and is able to make the light emitted by the first burner 424 into the first light beam 421. And the second lamp 430 includes a second reflective lampshade 432 and a second burner 434 disposed inside the second reflective lampshade 432. The second reflective lampshade 432 has the second light emitting section 433 and is able to make the light emitted by the second burner 434 into the second light beam 431.

In more detail, the first reflective lampshade 422 and the second reflective lampshade 432 are, for example, an ellipsoidal surface reflective lampshade. The first reflective lampshade 422 has two focuses F1 and F3, and the first burner 424 is disposed at the focus F1. The first reflective element 410 is, for example, a plane mirror and disposed at the focus F3. The second burner 434 is disposed at a focus F2 of the second reflective lampshade 432. The focus F3 is the conjugate focus of the focus F1 and the focus F2. The second reflective element 440 is, for example, a plane mirror, which is inclined to the first axis 60 and to the second axis 70 with an angle of, but not limited by the present embodiment, 45 degrees, respectively. The second reflective element 440 is located, for example, in front of half the first light emitting section 423 (a part of the first light emitting section 423 on the right of the first axis 60 shown in FIG. 4, for example) and in front of half the second light emitting section 433 (a part of the second light emitting section 433 below the second axis 70 shown in FIG. 4, for example).

In the embodiment, a part of the first light beam 421 passing a part of the first light emitting section 423 on the right of the first axis 60 is reflected by the first reflection surface 442 of the second reflective element 440 and then transmits in the direction away from the second lamp 430 (as shown by the light rays 421a) The other part of the first light beam 421 passing a part of the first light emitting section 423 on the left of the first axis 60 is sequentially reflected by the first reflective element 410, the second reflection surface 444 of the second reflective element 440 and the second reflective lampshade 432, and then transmits in the direction away from the second lamp 430 (as shown by the light rays 421b). In addition, a part of the second light beam 431 passing a part of the second light emitting section 433 above the second axis 70 is directly combined with the first light beam 421 transmitting in the direction away from the second lamp 430 (as shown by the light rays 431a). The other part of the second light beam 431 passing the part of the second light emitting section 433 below the second axis 70 is sequentially reflected by the second reflection surface 444 of the second reflective element 440, the first reflective element 410, the first reflective lampshade 422 and the first reflection surface 442 of the second reflective element 440, and then is combined with the first light beam 421 transmitting in the direction away from the second lamp 430 (as shown by the light rays 431b).

Since the illumination system 400 of the embodiment employs fewer components and has a compact structure, the assembly accuracy thereof is higher. Note that the illumination system 400 of the embodiment does not employ an LIR 210 (as shown in FIG. 2) which has a s complex tructure and high cost, hence it contributes to save the cost. In addition, most of the first light beam 421 and the second light beam 431 are able to be combined with each other, thus, the illumination system 400 of the embodiment has a higher light combining efficiency. In particular, theoretically, the etendue of the combined light beam does not change after combining, which results in a better light utilization efficiency with the illumination system 400 of the embodiment. Moreover, in case that one of the first lamp 420 and the second lamp 430 is damaged, the light uniformity is not seriously affected thereby, since the light beam transmitting in the direction away from the second lamp 430 still keeps an adequately symmetric distribution of light intensity about the axis 70.

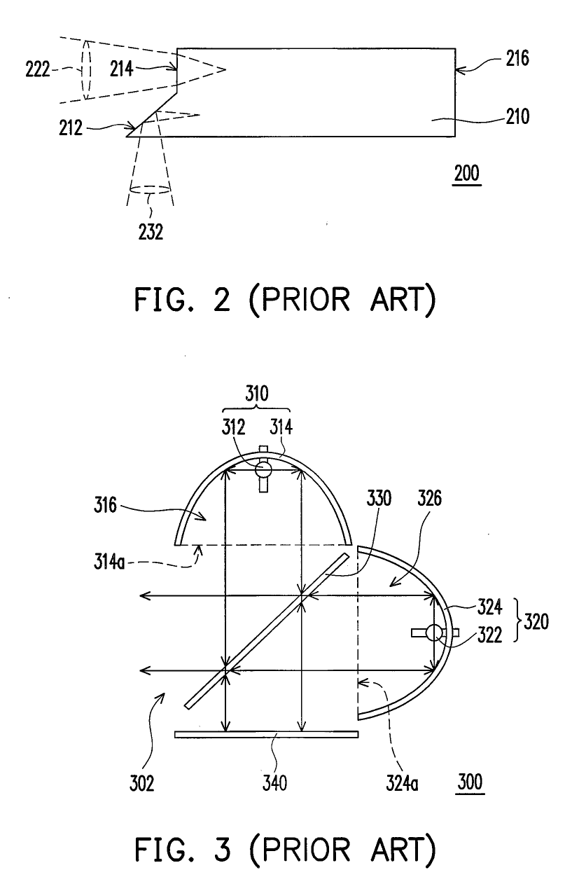

What is more, in comparison with the conventional layout shown in FIG. 3, the second reflective element 440 of the present embodiment is located in front of a part of the first light emitting section 423 and a part of the second light emitting section 433 only, therefore the second reflective element 440 has a smaller size and a saving cost. Furthermore, the part of the first light beam 421 and the part of the second light beam 431 transmit directly in the direction away from the second lamp 430 or to the first reflective element 410 without getting reflected by the second reflective element 440, so that the heat of light accumulated in the second reflective element 440 is reduced, and the optical paths of the light beams are shortened to improve the light converging efficiency.

The illumination system 400 of the embodiment further includes a light converging element 450 disposed on the second axis 70, and the second reflective element 440 is located between the light converging element 450 and the second lamp 430. The light converging element 450 is disposed at, for example, the convergence of the combining of the first light beam 421 and the second light beam 431. The light converging element 450 can be an LIR, a lens array, a mirror or a combination thereof, and the LIR can be a hollow LIR or a solid LIR.

It is noted that the first reflective element 410 and the second reflective element 440 can be a cold mirror or a layer of coating capable of filtering the infrared light and ultraviolet light therefrom to reduce the temperature inside the illumination system 400, so as to lengthen the lifetime of the first lamp 420 and the second lamp 430 and to advance the reliability of the components employed in the illumination system 400. Furthermore, in the embodiment, the reflective indexes over the visible light spectrum of the first reflective element 410 and the second reflective element 440 can be controlled for adjusting the chromatic temperature of the combining of the first light beam 421 and the second light beam 431.

### The Second Embodiment

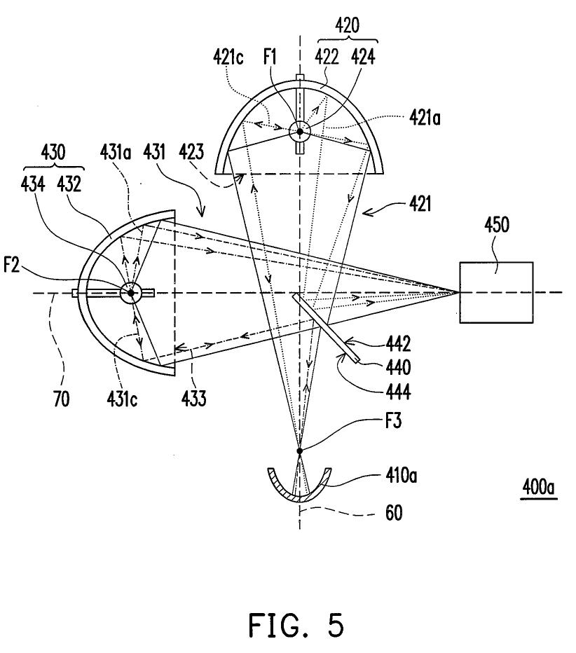

FIG. 5 is a diagram of an illumination system according to a second embodiment of the present invention. The illumination system 400a of the embodiment is similar to the illumination system 400 in FIG. 4 except that the first reflective element 410a in the illumination system 400a is a spherical mirror and the sphere center is overlapped with the focus F3 thereof.

In the embodiment, a part of a first light beam 421 passing a part of a first light emitting section 423 on the right of the first axis 60 is reflected by a first reflection surface 442 of a second reflective element 440 and then transmits in a direction away from the second lamp 430 (as shown by the light rays 421a). A part of the first light beam 421 passing a part of the first light emitting section 423 on the left of the first axis 60 is reflected by a first reflective element 410a back into the first reflective lampshade 422 along an original routine, and then is sequentially reflected by a first reflective lampshade 422 and the first reflection surface 442 of the second reflective element 440 and further transmits away from the second lamp 430 (as shown by the light rays 421c). In addition, a part of a second light beam 431 passing a part of the second light emitting section 433 above a second axis 70 is directly combined with the first light beam 421 transmitting in the direction away from the second lamp 430 (as shown by the light rays 431a). A part of the second light beam 431 passing a part of the second light emitting section 433 below the second axis 70 is reflected by a second reflection surface 444 of the second reflective element 440 and arrives at the first reflective element 410a, and then is reflected back to a second reflective lampshade 432 along an original routine. The second reflective lampshade 432 further reflects it and makes it combined with the first light beam 421 transmitting away from the second lamp 430 (as shown by the light rays 431c).

Since the first reflective element 410a of the embodiment is a spherical mirror, the first reflective element 410a does not need to directly be located at the focus F3 where the light rays converge at, and an overheat of the first reflective element 410a is avoided. Further, the curvature of the first reflective element 410a in the embodiment can be adjusted to advance the light converging efficiency of the illumination system 400a according to the characteristics of the first lamp and the second lamp. Note that the first reflective element in the embodiment can alternately be implemented by an ellipsoidal mirror, and a focus of the ellipsoidal mirror is overlapped with the focus F3.

### The Third Embodiment

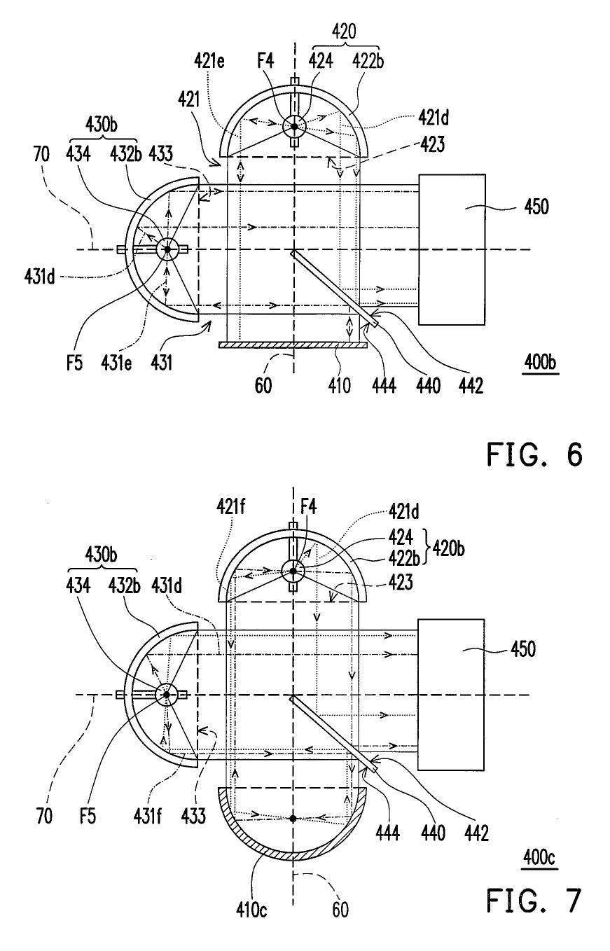

FIG. 6 is a diagram of an illumination system according to a third embodiment of the present invention. Referring to FIG. 6, the illumination system 400b is capable of providing a parallel light beam, and is similar to the illumination system 400 of the first embodiment (as shown by FIG. 4) except that a first reflective lampshade 422b and a second reflective lampshade 432b of the illumination system 400b are respectively a parabolic reflective lampshade, which make a first light beam and a second light beam provided respectively by a first lamp 420b and a second lamp 430b being parallel light beams. In the embodiment, a first burner 424 is disposed at a focus F4 of the first reflective lampshade 422b, while a second burner 434 is disposed at a focus F5 of the first reflective lampshade 432b.

In the embodiment, a part of the first light beam 421 passing a part of the first light emitting section 423 on the right of the first axis 60 is reflected by the first reflection surface 442 of the second reflective element 440 and then transmits in a direction away from the second lamp 430 (as shown by the light rays 421d). A part of the first light beam 421 passing a part of the first light emitting section 423 on the left of the first axis 60 is reflected by the first reflective element 410, returns back into the first reflective lampshade 422b along an original routine, then is reflected sequentially by the first reflective lampshade 422b and a first reflection surface 442 of a second reflective element 440 and further transmits away from the second lamp 430b (as shown by the light rays 421e). In addition, a part of the second light beam 431 passing a part of the second light emitting section 433 above the second axis 70 is directly combined with the first light beam 421 transmitting in the direction away from the second lamp 430b (as shown by the light rays 431d) A part of the second light beam 431 passing a part of the second light emitting section 433 below the second axis 70 is reflected by a second reflection surface 444 of the second reflective element 440 and arrives at the first reflective element 410. The first reflective element 410 reflects it back to the second reflective lampshade 432 along an original routine, and then the second reflective lampshade 432b reflects it and makes it combined with the first light beam 421 transmitting away from the second lamp 430b (as shown by the light rays 431e).

### The Fourth Embodiment

FIG. 7 is a diagram of an illumination system according to a fourth embodiment of the present invention. Referring to FIG. 70, the illumination system 400c of the embodiment is similar to the illumination system 400b of the third embodiment except that a first reflective element 410 of the illumination system 400b is a plane mirror, while the first reflective element 410c of the illumination system 400c is a parabolic mirror.

In the illumination system 400c, a part of the first light beam 421 passing a part of the first light emitting section 423 on the right of the first axis 60 is reflected by a first reflection surface 442 of a second reflective element 440 and then transmits in a direction away from the second lamp 430b (as shown by the light rays 421d). A part of the first light beam 421 passing a part of the first light emitting section 423 on the left of the first axis 60 is reflected sequentially by a first reflective element 410c, a second reflection surface 444 of the second reflective element 440 and a second reflective lampshade 432b and then transmits in the direction away from the second lamp 430b (as shown by the light rays 421f). In addition, a part of the second light beam 431 passing a part of the second light emitting section 433 above the second axis 70 is directly combined with the first light beam 421 transmitting in the direction away from the second lamp 430b (as shown by the light rays 431d). A part of the second light beam 431 passing a part of the second light emitting section 433 below the second axis 70 is reflected sequentially by a second reflection surface 444 of the second reflective element 440, a first reflective element 410c, a first reflective lampshade 422b and the first reflection surface 442 of the second reflective element 440 and then is combined with the first light beam 421 transmitting away from the second lamp 430b (as shown by the light rays 43 if).

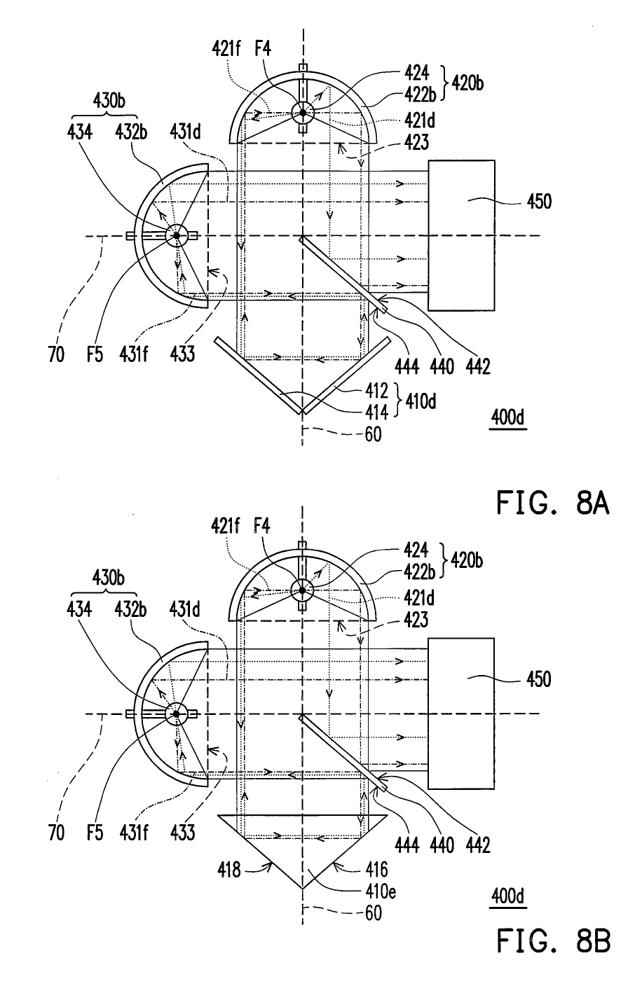

Note that, according to the present invention, the first reflective element 410c in FIG. 7 can be substituted by a first reflective element 410d shown in FIG. 8A or a first reflective element 410e shown in FIG. 8B. In more detail, the first reflective element 410d in an illumination system 400d shown by FIG. 8A includes two plane mirrors 412 and 414 connected in V-shape layout, and a vertex thereof is located on the first axis 60 and at the most far point of the plane mirrors from the first lamp 420b. Both the plane mirrors 412 and 414 are inclined to the first axis 60 with a degree of, for example, 45 degree. In addition, the first reflective element 410e in an illumination system 400e shown by FIG. 8B is a prism having two total refection surfaces 416 and 418 in V-shape layout, and a vertex thereof is located on the first axis 60 and at the most far point of the prism from the first lamp 420b. Both the two total refection surfaces 416 and 418 are inclined to the first axis 60 with a degree of, for example, 45 degree.

The illumination systems 400c, 400d and 400e of the embodiment have the advantages similar to those of the first embodiment, and they are omitted to describe herein for simplicity.

### The Fifth Embodiment

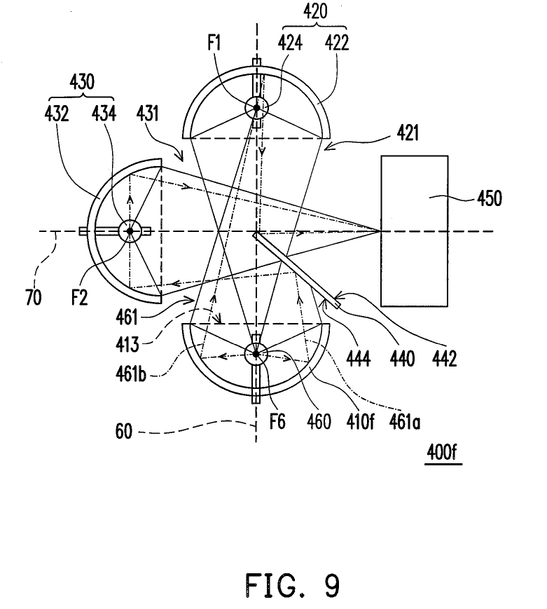

FIG. 9 is a diagram of an illumination system according to a fifth embodiment of the present invention. Referring to FIG. 9, the illumination system 400f is similar to the illumination system 400 of the first embodiment except that a first reflective element 410f is an ellipsoidal reflective lampshade and the illumination system 400f further includes a third burner 460. The third burner 460 is disposed at a focus F6 of the first reflective element 410f, which is making the third burner 460 emitting a third light beam 461. In other words, the illumination system 400f has a third lamp formed by the first reflective element 410f and the third burner 460.

In the embodiment, an focus F1 is, for example, the conjugate focus of the focus F6. The first reflective element 410f has a third light emitting section 413. A part of the third light beam 461 passing a part of the third light emitting section 413 on the right of the first axis 60 is reflected by a second reflection surface 444 of a second reflective element 440, and arrives at the second reflective lampshade 432 where the beam is further reflected thereby and then is combined with the first light beam 421 and the second light beam 431 both transmitting away from the second lamp 430b (as shown by the light rays 461a). A part of the third light beam 461 passing a part of the third light emitting section 413 on the right of the first axis 60 is reflected sequentially by a first reflective lampshade 422, a first reflection surface 442 of the second reflective element 440 and then is combined with the first light beam 421 and the second light beam 431 both transmitting away from the second lamp 430b (as shown by the light rays 461b).

In comparison with the illumination system 400, the present embodiment employs one more lamp, for example, the third lamp, thus, the luminance of an illumination light beam provided by the illumination system 400f is further increased.

### The Sixth Embodiment

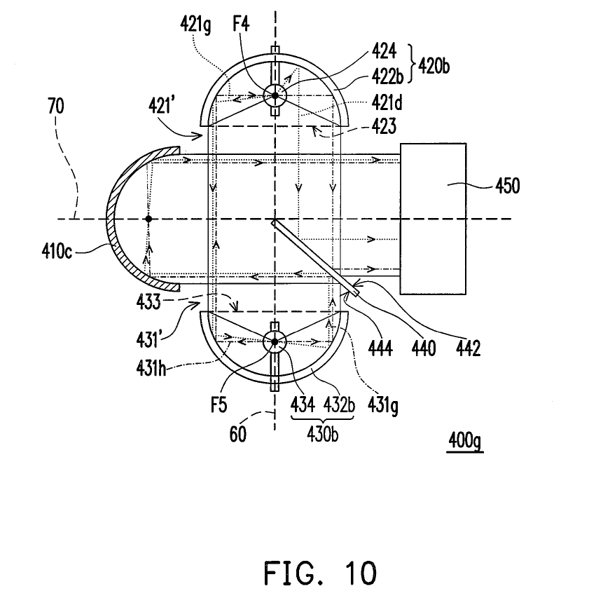

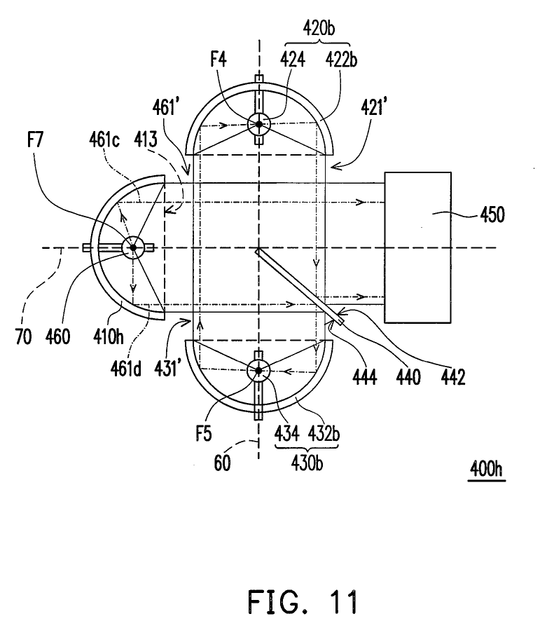

FIG. 10 is a diagram of an illumination system according to a sixth embodiment of the present invention. All the same components in FIG. 10 as the ones in FIG. 7 are represented by the same reference numbers. Referring to FIG. 10, the illumination system 400g of the present embodiment includes a first reflective element 410c, a first lamp 420b, a second lamp 430b and a second reflective element 440. The first lamp 420b and the second lamp 430b are disposed on a first axis 60, the first reflective element 410c is disposed on a second axis 70 intersecting the first axis 60, and the first lamp 420b and the second lamp 430b are located at both sides of the second axis 70 and opposite to each other. The second reflective element 440 is disposed between the first lamp 420b and the second lamp 430b and located in front of a part of a first light emitting section 423 of the first lamp 420b and in front of a part of the second light emitting section 433 of the second lamp 430b. In addition, the first lamp 420b provides a first parallel light beam 421′ and the second lamp 430b provides a second parallel light beam 431′. After the first parallel light beam 421′ and the second parallel light beam 431′ are reflected by at least one of the first lamp 420b, the second lamp 430b, the first reflective element 410c and the second reflective element 440, the light beams 421′ and 431′ are combined with each other, and then continually transmits in a direction away from the first reflective element 410c.

In the illumination system 400g, a part of the first parallel light beam 421′ passing a part of the first light emitting section 423 on the right of the first axis 60 is reflected by a first reflection surface 442 of the second reflective element 440 and then transmits in a direction away from the second lamp 430b (as shown by the light rays 421d). A part of the first parallel light beam 421′ passing ta part of the first light emitting section 423 on the left of the first axis 60 is reflected sequentially by the second reflective lampshade 432b, a second reflection surface 444 of the second reflective element 440 and the first reflective element 410c and then transmits in the direction away from the second lamp 430b (as shown by the light rays 421g). In addition, a part of the second parallel light beam 431′ passing a part of the second light emitting section 433 on the right of the second axis 60 is reflected sequentially by the second reflection surface 444 of the second reflective element 440 and the first reflective element 410c and then is combined with the first parallel light beam 421′ transmitting in the direction away from the first reflective element 410c (as shown by the light rays 431g). A part of the second parallel light beam 431′ passing apart of the second light emitting section 433 on the left of the first axis 60 is reflected sequentially by the first reflective lampshade 422b and the first reflection surface 442 of the second reflective element 440, and then is combined with the first parallel light beam 421′ transmitting away from the first reflective element 410c (as shown by the light rays 431h).

The illumination system 400g has the advantages similar to those of the illumination system 400, thus, it is omitted to describe herein. Furthermore, the first reflective element 410c in FIG. 10 can be substituted by the first reflective element 410 of FIG. 6, the first reflective element 410d of FIG. 8A or the first reflective element 410e of FIG. 8B.

### The Seventh Embodiment

FIG. 11 is a diagram of an illumination system according to a seventh embodiment of the present invention. Referring to FIG. 11, the illumination system 400h of the embodiment is similar to the illumination system 400g in FIG. 10 except that a first reflective element 410h in the illumination system 400h is a parabolic reflective lampshade and the illumination system 400h further includes a third burner 460. The third burner 460 is disposed at a focus F7 of the first reflective element 410h. The first reflective element 410h is making the light emitted by the third burner 460 into a third parallel light beam 461′. In other words, the illumination system 400h has a third lamp formed by the first reflective element 410h and the third burner 460.

In the embodiment, the first reflective element 410h has a third light emitting section 413. A part of the third parallel light beam 461′ passing a part of the third light emitting section 413 above a second axis 70 is directly combined with the first parallel light beam 421′ and the second parallel light beam 431′ both transmitting away from the first reflective element 410h (as shown by the light rays 461c). A part of the third parallel light beam 461′ passing a part of the third light emitting section 413 below the second axis 70 is reflected sequentially by a second reflection surface 444 of a second reflective element 440, a second reflective lampshade 432b, a first reflective lampshade 422 and a first reflection surface 442 of a second reflective element 440, and then is combined with the first parallel light beam 421′ and the second parallel light beam 431′ both transmitting away from the first reflective element 410h (as shown by the light rays 461d).

In comparison with the illumination system 400g, the present embodiment employs one more lamp, for example, the third lamp, thus, the luminance of an illumination light beam provided by the illumination system 400h is further increased.

### The Eighth Embodiment

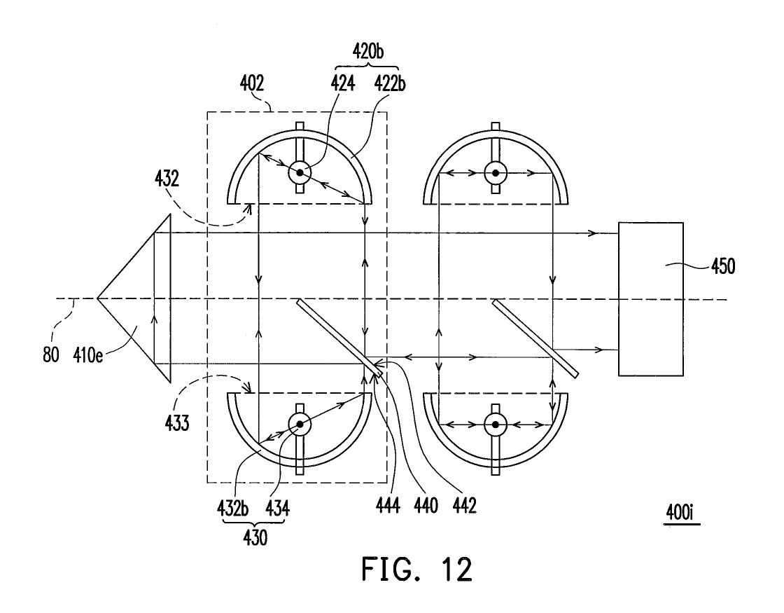

FIG. 12 is a diagram of an illumination system according to an eighth embodiment of the present invention. All the same components in FIG. 12 as the ones in FIG. 11 are represented by the same reference numbers. Referring to FIG. 12, the illumination system 400i of the present embodiment includes a first reflective element 410e and multiple light source modules 402. The first reflective element 410e is disposed on an axis 80, while the light source modules 402 are disposed at a side of the first reflective element 410e and located on the axis 80. Each of the light source modules 402 includes a first lamp 420b, a second lamp 430b and a second reflective element 440. The first lamp 420b and the second lamp 430b are disposed at both sides of the axis 80. The second reflective element 440 is disposed between the first lamp 420b and the second lamp 430b, and is located in front of a part of a first light emitting section 423 of the first lamp 420b and in front of a part of a second light emitting section 433 of the second lamp 430b. In addition, the first lamp 420b, the second lamp 430b, the first reflective element 410e and the second reflective element 440 are reflecting a first parallel light beam and a second parallel light beam provided by the first lamp 420b and the second lamp 430b, respectively (in FIG. 12, all the lines marked with arrows represent the first parallel light beam and the second parallel light beam, and the arrow indicates the directions the light beam transmits in). Moreover, the first parallel light beam and the second parallel light beam are reflected by at least one of the first lamp 420b, the second lamp 430b, the first reflective element 410e and the second reflective element 440, and then are combined with each other and then transmit in a direction away from the first reflective element 410e.

The illumination system 400i of the embodiment employs multiple light source modules 402, which provide multiple light beams and are capable of producing an illumination light beam with high luminance after combining the original light beams the light source modules 402 provide. In FIG. 12, only two light source modules 402 are show. However, the present invention does not limit the quantity of the light source modules 402.

In the present invention, the first reflective element 410e in FIG. 12 can be substituted by the first reflective element 410c in FIG. 7 or the first reflective element 410d in FIG. 8A. The first reflective element 410e can be substituted by the first reflective element 410h of FIG. 11, and a third burner 460 is disposed in the first reflective element 410h (as shown in FIG. 11).

In summary, the illumination system of the present invention has at least the following advantages:

1. The illumination system of the present invention employs fewer components, and has a compact structure and higher assembly accuracy.

2. There is no need to utilize the components with complex structure and expensive cost, which contributes to save production cost.

3. Most of the first light beam and the second light beam are combined into a light beam, therefore a better high light converging efficiency is obtained. The etendue of the resulted light beam is theoretically the same as the etendue of the light beam provided by a conventional illumination system with single lamp, which results in a better light utilization efficiency.

4. In case that one of the first lamp and the second lamp is damaged, the light uniformity is not seriously affected thereby, since the illumination light beam still keeps an adequately-symmetric distribution of light intensity about the axis of the light beam.

5. In one embodiment of the present invention, the illumination system has multiple light source modules, which is capable of providing an illumination light beam with high luminance.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An illumination system, comprising:
a first reflective element, disposed on a first axis;
a first lamp, disposed on the first axis, the first lamp having a first light emitting section and emitting a first light beam towards the first reflective element;
a second lamp, disposed on a second axis intersecting the first axis, the second lamp having a second light emitting section and emitting a second light beam towards the intersection of the first axis and the second axis, the first reflective element and the first lamp being located at opposite sides of the second axis; and
a second reflective element, disposed between the first lamp and the first reflective element, the second reflective element located in front of a part of the first light emitting section and a part of the second light emitting section, and having a first reflection surface and a second reflection surface opposite to each other, the first reflection surface facing the first light emitting section, the second reflection surface facing the second light emitting section,
wherein a part of the second light beam transmits directly in a direction away from the second lamp, the first light beam and another part of the second light beam are reflected by at least one of the first lamp, the second lamp, the first reflective element and the second reflective element, and further transmit in the direction away from the second lamp and then are combined with the part of the second light beam transmitting directly in the direction away from the second lamp.

2. The illumination system as recited in claim 1, wherein the first axis and the second axis are substantially perpendicular to each other.

3. The illumination system as recited in claim 1, wherein
the first lamp comprises:
a first reflective lampshade;
a first burner, disposed in the first reflective lampshade, the first reflective lampshade being making the light emitted by the first burner into the first light beam;
the second lamp comprises:
a second reflective lampshade; and
a second burner, disposed in the second reflective lampshade, the second reflective lampshade being making the light emitted by the second burner into the second light beam.

4. The illumination system as recited in claim 3, wherein the first reflective lampshade and the second reflective lampshade are respectively an ellipsoidal reflective lampshade, the first burner is disposed at a focus of the first reflective lampshade and the second burner is disposed at a focus of the second reflective lampshade.

5. The illumination system as recited in claim 4, wherein the first reflective element comprises a plane mirror disposed at the conjugate focus of the focus of the first reflective lampshade and the focus of the second reflective lampshade.

6. The illumination system as recited in claim 4, wherein the first reflective element comprises a spherical mirror, and the sphere center of the spherical surface mirror is overlapped with the conjugate focus of the focus of the first reflective lampshade and the focus of the second reflective lampshade.

7. The illumination system as recited in claim 4, further comprising a third burner, the first reflective element comprising an ellipsoidal reflective lampshade, the third burner being disposed at a focus of the first reflective element, and the first reflective element making the light emitted by the third burner into a third light beam.

8. The illumination system as recited in claim 3, wherein the first reflective lampshade and the second reflective lampshade are respectively a parabolic reflective lampshade, the first burner is disposed at a focus of the first reflective lampshade, and the second burner is disposed at a focus of the second reflective lampshade.

9. The illumination system as recited in claim 8, wherein the first reflective element comprises a plane mirror or a parabolic mirror.

10. The illumination system as recited in claim 8, wherein the first reflective element comprises two plane mirrors connected in V-shape layout, a vertex of the V-shape is located on the first axis and at the most far point of the plane mirrors from the first lamp.

11. The illumination system as recited in claim 8, wherein the first reflective element comprises a prism having two total reflection surfaces in V-shape layout, a vertex thereof is located on the first axis and at the most far point of the prism from the first lamp.

12. The illumination system as recited in claim 1, wherein the second reflective element comprises a plane mirror.

13. The illumination system as recited in claim 1, further comprising a light converging element disposed on the second axis, wherein the second reflective element is located between the light converging element and the second lamp.

14. An illumination system, comprising:
a first lamp, disposed on a first axis, the first lamp having a first light emitting section and emitting a first parallel light beam;
a second lamp, disposed on the first axis, the second lamp having a second light emitting section opposite to the first light emitting section and emitting a second parallel light beam;
a first reflective element, disposed on a second axis intersecting the first axis, the first lamp and the second lamp being located at opposite sides of the second axis; and
a second reflective element, disposed between the first lamp and the second lamp and located in front of a part of the first light emitting section and a part of the second light emitting section, the second reflective element having a first reflection surface and a second reflection surface opposite to each other, the first reflection surface facing the first light emitting section, while the second reflection surface facing the second light emitting section,
wherein the first parallel light beam and the second parallel light beam are reflected by at least one of the first lamp, the second lamp, the first reflective element and the second reflective element, and then are combined with each other and further transmit in a direction away from the first reflective element.

15. The illumination system as recited in claim 14, wherein the first axis and the second axis are substantially perpendicular to each other.

16. The illumination system as recited in claim 14, wherein
the first lamp comprises:
a first reflective lampshade, being a parabolic reflective lampshade;
a first burner, disposed at a focus of the first reflective lampshade, the first reflective lampshade making the light emitted by the first burner into the first parallel light beam;
the second lamp comprises:
a second reflective lampshade, being a parabolic reflective lampshade; and
a second burner, disposed at a focus of the second reflective lampshade, the second reflective lampshade making the light emitted by the second burner into the second parallel light beam.

17. The illumination system as recited in claim 14, wherein the first reflective element comprises a parabolic mirror or a plane mirror.

18. The illumination system as recited in claim 14, further comprising a third burner, the first reflective element comprising a parabolic reflective lampshade, the third burner being disposed at a focus of the first reflective element, and the first reflective element making the light emitted by the third burner into a third parallel light beam.

19. The illumination system as recited in claim 14, wherein the first reflective element comprises two plane mirrors connected in V-shape layout, a vertex of the V-shape is located on the second axis and at the most far point of the plane mirrors from the second reflective element.

20. The illumination system as recited in claim 14, wherein the first reflective element comprises a prism having two total reflection surfaces in V-shape layout, a vertex thereof is located on the second axis and at the most far point of the prism from the second reflective element.

21. The illumination system as recited in claim 14, wherein the second reflective element comprises a plane mirror.

22. The illumination system as recited in claim 14, further comprising a light converging element disposed on the second axis, the second reflective element being located between the light converging element and the first reflective element.

23. An illumination system, comprising:
a first reflective element, disposed on an axis;
multiple light source modules, disposed at a side of the first reflective element and located on the axis, each of the light source modules comprising:
a first lamp, having a first light emitting section and emitting a first parallel light beam;
a second lamp, the first lamp and the second lamp being located at opposite sides of the axis, the second lamp having a second light emitting section opposite to the first light emitting section and emitting a second parallel light beam; and
a second reflective element, disposed between the first lamp and the second lamp and located in front of a part of the first light emitting section and a part of the second light emitting section, the second reflective element having a first reflection surface and a second reflection surface opposite to each other, the first reflection surface facing the first light emitting section, and the second reflection surface facing the second light emitting section,
wherein the first parallel light beams and the second parallel light beams are reflected by at least one of the first lamps, the second lamps, the first reflective element and the second reflective elements, and then are combined with each other and further transmit in a direction away from the first reflective element.

24. The illumination system as recited in claim 23, wherein
each of the first lamps comprises:
a first reflective lampshade, being a parabolic reflective lampshade;
a first burner, disposed at a focus of the first reflective lampshade, the first reflective lampshade making the light emitted by the first burner into the first parallel light beam;
each of the second lamps comprises:
a second reflective lampshade, being a parabolic reflective lampshade; and
a second burner, disposed at a focus of the second reflective lampshade, the second reflective lampshade making the light emitted by the second burner into the second parallel light beam.

25. The illumination system as recited in claim 23, wherein the first reflective element comprises a parabolic mirror.

26. The illumination system as recited in claim 23, wherein the first reflective element comprises two plane mirrors connected in V-shape layout, a vertex of the V-shape is located on the axis and at the most far point of the plane mirrors from the second reflective element.

27. The illumination system as recited in claim 23, wherein the first reflective element comprises a prism having two total reflection surfaces in V-shape layout, a vertex thereof is located on the axis and at the most far point of the prism from the second reflective element.

28. The illumination system as recited in claim 23, wherein the second reflective element comprises a plane mirror.

29. The illumination system as recited in claim 23, further comprising a light converging element disposed on the axis, the second reflective element being located between the light converging element and the first reflective element.
